(19) United States
(12) Patent Application Publication
(10) Pub. No.: US 2023/0214234 A1
(43) Pub. Date: Jul. 6, 2023

(54) SYSTEMS AND METHODS FOR CONFIGURATION-BASED PERFORMANCE PROFILE

(71) Applicant: Dell Products L.P., Round Rock, TX (US)

(72) Inventors: Jose M. GRANDE, Round Rock, TX (US); Christopher D. COTE, Leander, TX (US)

(73) Assignee: Dell Products L.P., Round Rock, TX (US)

(21) Appl. No.: 17/570,134

(22) Filed: Jan. 6, 2022

(51) Int. Cl. G06F 9/445

(52) U.S. Cl. CPC G06F 9/4451

(57) ABSTRACT

An information handling system may include a processor and a basic input/output system (BIOS) embodied as executable instructions in non-transitory computer-readable media communicatively coupled to the processor and configured to, when read and executed by the processor, during a Driver Execution Environment of the BIOS, collect an inventory of hardware of the information handling system, generate a configuration-based performance profile based on the inventory and empirical data related to the inventory, present to a user of the information handling system, during a setup utility of the BIOS, a performance workload table setting forth a plurality of performance profiles including the configuration-based performance profile, and in response to the user selecting a performance profile from the plurality of performance profiles, apply the performance profile to a remainder of execution of the BIOS.

### TECHNICAL FIELD

The present disclosure relates in general to information handling systems, and more particularly to methods and systems for providing a configuration-based performance profile for use by a basic input/output system (BIOS) of an information handling system.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A BIOS may include any system, device, or apparatus configured to identify, test, and/or initialize information handling resources of an information handling system, and/or initialize interoperation of an information handling system with other information handling systems. A BIOS may often be the first executable code that runs when an information handling system powers on or initializes.

Under existing approaches, a loss of performance benefits to specific BIOS performance options may be present under certain hardware (e.g., processor and memory) configurations of an information handling system. This loss of performance benefits may result because, under existing approaches, performance profiles within BIOS are statically determined and offered to users as a one-profile-fits-all configuration, which may only consider what options are recommended by a chipset vendor.

### SUMMARY

In accordance with the teachings of the present disclosure, the disadvantages and problems associated with BIOS configuration may be reduced or eliminated.

In accordance with embodiments of the present disclosure, an information handling system may include a processor and a basic input/output system (BIOS) embodied as executable instructions in non-transitory computer-readable media communicatively coupled to the processor and configured to, when read and executed by the processor, during a Driver Execution Environment of the BIOS, collect an inventory of hardware of the information handling system, generate a configuration-based performance profile based on the inventory and empirical data related to the inventory, present to a user of the information handling system, during a setup utility of the BIOS, a performance workload table setting forth a plurality of performance profiles including the configuration-based performance profile, and in response to the user selecting a performance profile from the plurality of performance profiles, apply the performance profile to a remainder of execution of the BIOS.

In accordance with these and other embodiments of the present disclosure, a method may include, in a basic input/output system (BIOS) of an information handling system during a Driver Execution Environment of the BIOS, collecting an inventory of hardware of the information handling system, generating a configuration-based performance profile based on the inventory and empirical data related to the inventory, presenting to a user of the information handling system, during a setup utility of the BIOS, a performance workload table setting forth a plurality of performance profiles including the configuration-based performance profile, and in response to the user selecting a performance profile from the plurality of performance profiles, applying the performance profile to a remainder of execution of the BIOS.

In accordance with these and other embodiments of the present disclosure, an article of manufacture may include a non-transitory computer-readable medium and computer-executable instructions carried on the computer-readable medium, the instructions readable by the processor, the instructions, when read and executed, for causing the processor to, in a basic input/output system (BIOS) of an information handling system during a Driver Execution Environment of the BIOS, collect an inventory of hardware of the information handling system, generate a configuration-based performance profile based on the inventory and empirical data related to the inventory, present to a user of the information handling system, during a setup utility of the BIOS, a performance workload table setting forth a plurality of performance profiles including the configuration-based performance profile, and in response to the user selecting a performance profile from the plurality of performance profiles, apply the performance profile to a remainder of execution of the BIOS.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a flowchart of an example method for selection of a configuration-based performance profile for a BIOS, in accordance with embodiments of the present disclosure.

### DETAILED DESCRIPTION

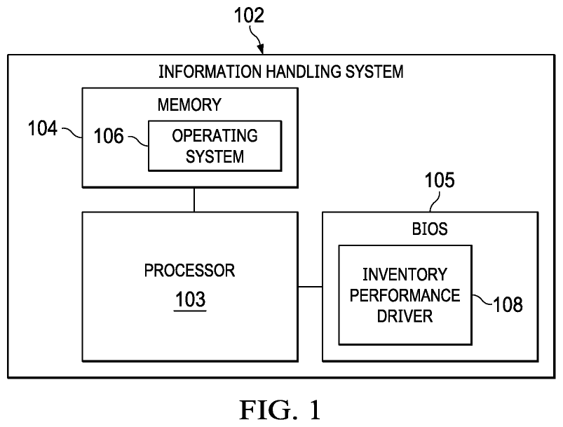

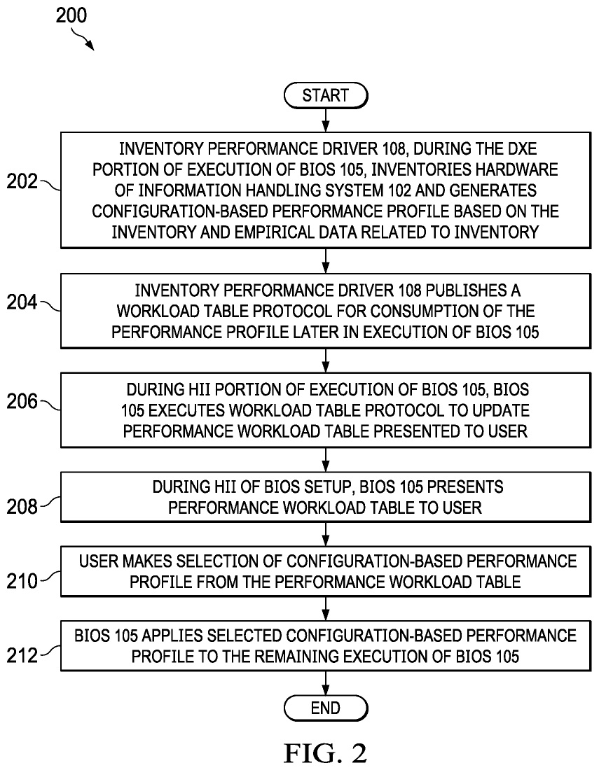

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, service processors, basic input/output systems, buses, memories, I/O devices and/or interfaces, storage resources, network interfaces, motherboards, and/or any other components and/or elements of an information handling system.

FIG. 1 illustrates a block diagram of an example information handling system 102, in accordance with embodiments of the present disclosure. In some embodiments, an information handling system 102 may comprise a personal computer. In some embodiments, an information handling system 102 may comprise or be an integral part of a server. In other embodiments, an information handling system 102 may comprise a portable information handling system (e.g., a laptop or notebook, etc.). As depicted in FIG. 1, an information handling system 102 may include a processor 103, a memory 104 communicatively coupled to processor 103, and a BIOS 105 communicatively coupled to processor 103.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions, or aggregation of programs of executable instructions, configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface. Active portions of operating system 106 may be transferred to memory 104 for execution by processor 103. Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

BIOS 105 may include any system, device, or apparatus configured to identify, test, and/or initialize information handling resources of information handling system 102, and/or initialize interoperation of information handling system 102 with other information handling systems. “BIOS” may broadly refer to any system, device, or apparatus configured to perform such functionality, including without limitation, a Unified Extensible Firmware Interface (UEFI). In some embodiments, BIOS 105 may be implemented as a program of instructions that may be read by and executed on processor 103 to carry out the functionality of BIOS 105. In these and other embodiments, BIOS 105 may comprise boot firmware configured to be the first code executed by processor 103 when information handling system 102 is booted and/or powered on. As part of its initialization functionality, code for BIOS 105 may be configured to set components of information handling system 102 into a known state, so that one or more applications (e.g., an operating system or other application programs) stored on compatible media (e.g., disk drives) may be executed by processor 103 and given control of information handling system 102.

As shown in FIG. 1, BIOS 105 may include an inventory performance driver 108. Inventory performance driver 108 may comprise a BIOS driver that may execute during the Driver eXecution Environment (DXE) portion of BIOS 105.

As described in greater detail below, inventory performance driver 108 may be configured to inventory hardware of information handling system 102 and generate a configuration-based performance profile based on the inventory and empirical data related to the inventory. In addition, inventory performance driver 108 may publish a workload table protocol for consumption of the performance profile later in execution of BIOS 105.

During the Human Interface Infrastructure (HII) portion of execution of BIOS 105, BIOS 105 may execute the workload table protocol, which may update a performance workload table presented (e.g., via a graphical user interface) to a user (e.g., administrator, information technology professional, or end user) during BIOS setup and present such table to the user. In some embodiments, BIOS 105 may provide an indication that the newly-created configuration-based performance profile is recommended. In response to a user selection of a configuration-based performance profile from the performance workload table, BIOS 105 may apply the selected configuration-based performance profile to remaining execution of BIOS 105.

FIG. 2 illustrates a flowchart of an example method 200 for selection of a configuration-based performance profile for a BIOS, in accordance with embodiments of the present disclosure. According to certain embodiments, method 200 may begin at step 202. As noted above, teachings of the present disclosure may be implemented in a variety of configurations of information handling system 102. As such, the preferred initialization point for method 200 and the order of the steps comprising method 200 may depend on the implementation chosen.

At step 202, inventory performance driver 108 may, during the DXE portion of execution of BIOS 105, inventory hardware of information handling system 102 and generate a configuration-based performance profile based on the inventory and empirical data related to the inventory. Such performance profile may be based on empirical data collected by a provider (e.g., vendor, manufacturer, etc.) of information handling system 102 and/or a component thereof during testing of similar information handling systems with one or more hardware components set forth in the inventory. At step 204, inventory performance driver 108 may publish a workload table protocol for consumption of the performance profile later in execution of BIOS 105.

At step 206, during the HII portion of execution of BIOS 105, BIOS 105 may execute the workload table protocol, which may update a performance workload table presented to a user. At step 208, during HII of BIOS setup, BIOS 105 may present the performance workload table to the user, wherein such performance workload table sets forth a plurality of performance profiles, including the configuration-based performance profile created at step 202. In some embodiments, presentation of the performance workload table to the user may only occur in response to a change in the performance workload table, as may occur in response to a change in hardware inventory of information handling system 102 and/or user input of a hotkey sequence for invoking BIOS setup. Thus, when no change occurs to the hardware inventory of information handling system 102 between successive executions of BIOS 105, BIOS setup may not be invoked and presentation of the performance workload table may not occur, unless BIOS setup is otherwise invoked responsive to user input of a hotkey sequence for invoking BIOS setup. In some embodiments, BIOS 105 may also provide an indication that a configuration-based performance profile newly created during the then-current BIOS session (e.g., created at step 202) is recommended.

At step 210, the user may (e.g., via a graphical user interface of BIOS setup) make a selection of a configuration-based performance profile from the performance workload table. At step 212, BIOS 105 may apply the selected configuration-based performance profile to the remaining execution of BIOS 105.

Although FIG. 2 discloses a particular number of steps to be taken with respect to method 200, it may be executed with greater or fewer steps than those depicted in FIG. 2. In addition, although FIG. 2 discloses a certain order of steps to be taken with respect to method 200, the steps comprising method 200 may be completed in any suitable order.

Method 200 may be implemented using information handling system 102, components thereof or any other system operable to implement method 200. In certain embodiments, method 200 may be implemented partially or fully in software and/or firmware embodied in computer-readable media.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

What is claimed is:

1. An information handling system, comprising:
a processor; and
a basic input/output system (BIOS) embodied as executable instructions in non-transitory computer-readable media communicatively coupled to the processor and configured to, when read and executed by the processor, during a Driver Execution Environment of the BIOS:
collect an inventory of hardware of the information handling system;
generate a configuration-based performance profile based on the inventory and empirical data related to the inventory;
present to a user of the information handling system, during a setup utility of the BIOS, a performance workload table setting forth a plurality of performance profiles including the configuration-based performance profile; and
in response to the user selecting a performance profile from the plurality of performance profiles, apply the performance profile to a remainder of execution of the BIOS.

2. The information handling system of claim 1, wherein the empirical data comprises data collected by a provider of the information handling system or a component thereof during testing of similar information handling systems with one or more hardware components set forth in the inventory.

3. The information handling system of claim 1, the BIOS further configured to, when presenting the performance workload table to the user, indicate to the user that the configuration-based performance profile is recommended for selection.

4. The information handling system of claim 1, wherein the BIOS is configured to present the performance workload table to the user in response to a change in the performance workload table occurring as a result of a change in the inventory of the information handling system since the last successive execution of the BIOS.

5. A method, comprising, in a basic input/output system (BIOS) of an information handling system during a Driver Execution Environment of the BIOS:
collecting an inventory of hardware of the information handling system;
generating a configuration-based performance profile based on the inventory and empirical data related to the inventory;
presenting to a user of the information handling system, during a setup utility of the BIOS, a performance workload table setting forth a plurality of performance profiles including the configuration-based performance profile; and
in response to the user selecting a performance profile from the plurality of performance profiles, applying the performance profile to a remainder of execution of the BIOS.

6. The method of claim 5, wherein the empirical data comprises data collected by a provider of the information handling system or a component thereof during testing of similar information handling systems with one or more hardware components set forth in the inventory.

7. The method of claim 5, further comprising the BIOS, when presenting the performance workload table to the user, indicating to the user that the configuration-based performance profile is recommended for selection.

8. The method of claim 5, further comprising the BIOS presenting the performance workload table to the user in response to a change in the performance workload table occurring as a result of a change in the inventory of the information handling system since the last successive execution of the BIOS.

9. An article of manufacture comprising:
a non-transitory computer-readable medium; and
computer-executable instructions carried on the computer-readable medium, the instructions readable by a processor, the instructions, when read and executed, for causing the processor to, in a basic input/output system (BIOS) of an information handling system during a Driver Execution Environment of the BIOS:
collect an inventory of hardware of the information handling system;
generate a configuration-based performance profile based on the inventory and empirical data related to the inventory;
present to a user of the information handling system, during a setup utility of the BIOS, a performance workload table setting forth a plurality of performance profiles including the configuration-based performance profile; and
in response to the user selecting a performance profile from the plurality of performance profiles, apply the performance profile to a remainder of execution of the BIOS.

10. The article of claim 9, wherein the empirical data comprises data collected by a provider of the information handling system or a component thereof during testing of similar information handling systems with one or more hardware components set forth in the inventory.

11. The article of claim 9, the instructions for further causing the BIOS to, when presenting the performance workload table to the user, indicate to the user that the configuration-based performance profile is recommended for selection.

12. The article of claim 9, the instructions for further causing the BIOS to present the performance workload table to the user in response to a change in the performance workload table occurring as a result of a change in the inventory of the information handling system since the last successive execution of the BIOS.
